(19) United States
(12) Patent Application Publication
(10) Pub. No.: US 2016/0358227 A1
(43) Pub. Date: Dec. 8, 2016

(54) COMPUTER EVENT-BASED PROCESSING TO IDENTIFY CONTENT TO INCLUDE IN MULTIPLE WEB PAGES

(71) Applicant: Yahoo! Inc., Sunnvyale, CA (US)

(72) Inventors: R. Preston McAfee, San Marino, CA (US); Daniel Goldstein, New York, NY (US); Siddharth Suri, Brooklyn, NY (US)

(21) Appl. No.: 15/242,338

(22) Filed: Aug. 19, 2016

Related U.S. Application Data
(62) Division of application No. 13/485,115, filed on May 31, 2012.

(51) Int. Cl. G06Q 30/02

(52) U.S. Cl. CPC G06Q 30/0272; G06Q 30/0277

(57) ABSTRACT

The amount of time that a web page is displayed by a browser is tracked. The amount that is charged to a content provider, whose content item is contained within the web page, is determined based on this amount of time. One way of tracking this amount of time is by tracking the amount of time that passes in between the moment that the web page is loaded by the web browser and the moment in which the web page goes out of focus. If the web page is displayed for less than a specified minimum amount of time during a first session, then the content item is displayed again during a second session. Once the content item has been displayed for a specified maximum amount of time, the content item is replaced with another content item on the web page.

### CROSS-REFERENCE TO RELATED APPLICATIONS; BENEFIT CLAIM

This application claims the benefit as a Divisional of application Ser. No. 13/485,115, filed May 31, 2012 the entire contents of which is hereby incorporated by reference as if fully set forth herein, under 35 U.S.C. §120. The applicant(s) hereby rescind any disclaimer of claim scope in the parent application(s) or the prosecution history thereof and advise the USPTO that the claims in this application may be broader than any claim in the parent application(s).

### TECHNICAL FIELD

The present disclosure relates to computer event-based processing, and, more specifically, to using computer events to identify content to include in multiple web pages. Recommended Art Unit: 2196; Recommended Classification: 719/318.

### BACKGROUND

Displaying certain content items is a multi-billion dollar industry that has traditionally used a pricing scheme based on the number of impressions delivered, which is the number of downloads of an ad. One impression, however, does not differentiate between a content item that is in view for five seconds or five minutes. Since content providers seek brand recognition and recall, one might ask whether a time-based accounting of content display can better align with content providers' goals.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram illustrating an example embodiment of a network;

FIG. 2 is a block diagram that illustrates a client device upon which an embodiment of the invention may be implemented;

FIG. 3 is a flow diagram that illustrates a technique for determining how long an advertisement has been in focus, according to an embodiment of the invention;

FIG. 4 is a flow diagram that illustrates a technique for ensuring that an advertisement is displayed to a user for a least a specified quantity of time, according to an embodiment of the invention;

FIG. 5 is a flow diagram that illustrates a technique for replacing a first advertisement with a second advertisement after the first advertisement has been displayed for a specified maximum amount of time, according to an embodiment of the invention;

FIG. 6 is a block diagram of a computer system on which embodiments of the invention may be implemented;

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

### OVERVIEW

The amount of time that an advertisement-presenting web page is displayed by a browser is tracked. The amount of money that is charged to an advertiser, whose advertisement is contained within the web page, is determined based on this amount of time. One way of tracking this amount of time is by tracking the amount of time that passes in between the moment that the web page is loaded by the web browser and the moment in which the web page goes out of focus. If the web page is displayed for less than a specified minimum amount of time during a first session, then the advertisement is displayed again during a second session. Once the advertisement has been displayed for a specified maximum amount of time, the advertisement is replaced with another advertisement on the web page.

### Advertisement Display Time-Based Charging

A variety of different measurements might be used in order to attempt to determine whether an online advertising campaign has been successful. An alternative to selling display ads based on impressions is to sell them based on time, which is how television and radio ads are traditionally sold. It has been discovered that measuring the amount of time that an advertisement—or a page containing that advertisement—has been in view is a better measure of the successfulness of the advertisement that is the quantity of impressions (i.e., the number of times that advertisement was displayed regardless of the length of time that the advertisement was displayed). It has also been discovered that the initial intervals of time during which an advertisement is being displayed tend to be more important, in terms of advertising effectiveness, than are later intervals of time during which that advertisement is being displayed.

Measuring the amount of time a user spends on a web page is straightforward. Simple JavaScript code can track the amount of time a page is open, or, alternatively, the amount of time such a page remains in focus. The amount of time users spend on a page is quite variable. Time spent ranges from a couple of seconds to well over two minutes.

In practice, the measurement of the time on the page benefits from a cap or limitation; the person who spends 24 hours on a single page does not produce 9,000 times as much recall as the person spending ten seconds. Theoretically, the right metric is the one that most closely approximates advertiser value, because this induces the efficient use of resources. Advertisers primarily judge campaigns by two criteria: ad recall and ad recognition. The amount of time that an advertisement is actually displayed by a browser serves as a useful proxy for ad recall.

An embodiment of the invention exploits the basic relationship between ad exposure time and the probability that a viewer will remember an advertisement. Using HTML commands onFocus and onBlur, it is possible to approximate the amount of time a particular advertisement is visible. Specifically, the body tag may read:

body onFocus=“timeon( )” onBlur=“timeoff( )”

where timeon( ) makes one call to a server and timeoff( ) makes another call to the server. Such server calls could be, for instance, to call for a 1 pixel by 1 pixel image file. These calls let the system track when the page is visible because it is in focus.

A similar technique can be used to track opening and closing documents containing advertisements, using:

body onFocus=“timeon( )” onBlur=“timeoff( )”

These calls may be sent to a server that tracks individual time on page, and then approximates advertiser value. A useful approximation is a cap, e.g., billable time=min{actual time, 1 minute}.

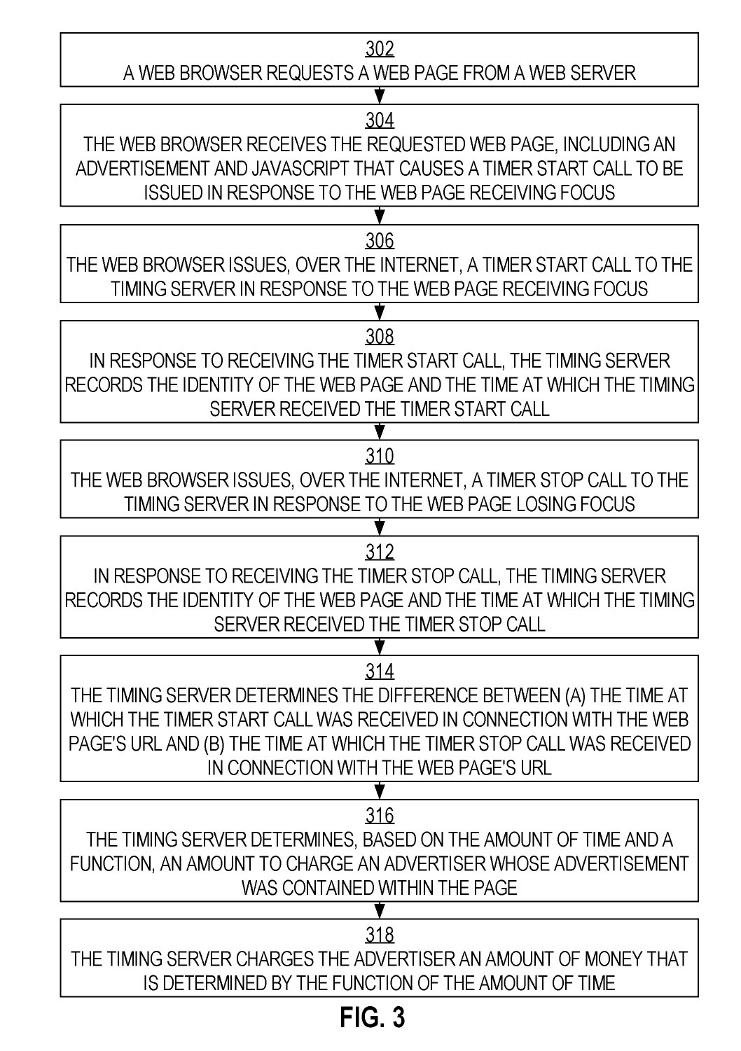

FIG. 3 is a flow diagram that illustrates a technique for determining how long an advertisement has been in focus, according to an embodiment of the invention. In block 302, a web browser requests a web page from a web server over the Internet. In block 304, the web browser receives, from the web server, over the Internet, the requested web page, including both (a) an advertisement and (b) JavaScript that causes a timer start call to be issued to a timing server the Internet in response to the web page receiving focus. According to one embodiment of the invention, the web page receives focus in response to the web browser loading the page and the web browser being in an active window—that is, the web browser not being obscured in part by any other windows. According to one embodiment of the invention, the timer start call is issued in response to an “onFocus” event occurring relative to the web page.

In block 306, the web browser issues, over the Internet, a timer start call to the timing server in response to the web page receiving focus. In block 308, in response to receiving the timer start call, the timing server records the identity of the web page (e.g., via the web page's URL) and the time at which the timing server received the timer start call. In one embodiment of the invention, the timing server additionally records information that indicates identities of advertisements that were present on the web page at the time that the timer start call was received, so that the appropriate advertiser can be charged for the display of those advertisements based on the actual amount of time that the web page was in focus.

According to one embodiment of the invention, the web page additionally includes JavaScript that causes a timer stop call to be issued to the timing server over the Internet in response to the web page losing focus. According to one embodiment of the invention, the web page loses focus in response to the web browser loading some other page, thereby replacing the original page, or in response to the web browser ceasing to be in an active window—that is, the web browser becoming obscured at least in part by some other window, or the web browser being closed completely. In a related embodiment, an advertisement is in “focus” if the advertisement is visible. An advertisement may not be obscured by any other window yet still not be in focus if the advertisement is on a portion of a web page that is not currently being displayed. In order for the advertisement to be visible in such a situation is for the user to scroll through the web page until the advertisement is visible. Thus, in this embodiment, a timer stop call may issued in response to a user scrolling through the web page such that an advertisement is no longer in view. A timer start call may then be issued if the user scrolls through the web page again such that the advertisement comes back into view.

In block 310, the web browser issues, over the Internet, a timer stop call to the timing server in response to the web page losing focus. According to one embodiment of the invention, the timer stop call is issued in response to an “onBlur” event occurring relative to the web page. In block 312, in response to receiving the timer stop call, the timing server records the identity of the web page (e.g., via the web page's URL) and the time at which the timing server received the timer stop call.

Potentially asynchronously with the foregoing activities, in block 314, the timing server determines the difference between (a) the time at which the timer start call was received in connection with the web page's URL and (b) the time at which the timer stop call was received in connection with the web page's URL. This difference represents the total amount of time that the advertisements on the web page were in focus. In block 316, the timing server determines, based on this amount of time, an amount to charge an advertiser whose advertisement was contained within the page. For example, the timing server may input the amount into a function that computes a cost based on the amount of time, but the function might not be linear; the function might, for example, increase the cost less at a lower rate as the amount of time increases. In block 318, the timing server charges the advertiser an amount of money that is determined by the function.

### Ensuring at Least Minimum Exposure Time

According to one embodiment of the invention, each advertisement is displayed to a user for at least a specified amount of time. If the web page loses focus before this specified amount of time is reached, then the same advertisement that was shown on the web page is displayed to the user on the same or a different web page the next time that the user's web browser loads that same or different web page. In one embodiment of the invention, this process is repeated until the advertisement has been in focus for the user for at least the specified amount of time, potentially spread over a number of separate web browser sessions. In other words, in one embodiment, if the advertisement has been displayed to a user for less than the specified amount of time during a first session of the user, then the same advertisement is selected for display to the user again during a separate second session of the user.

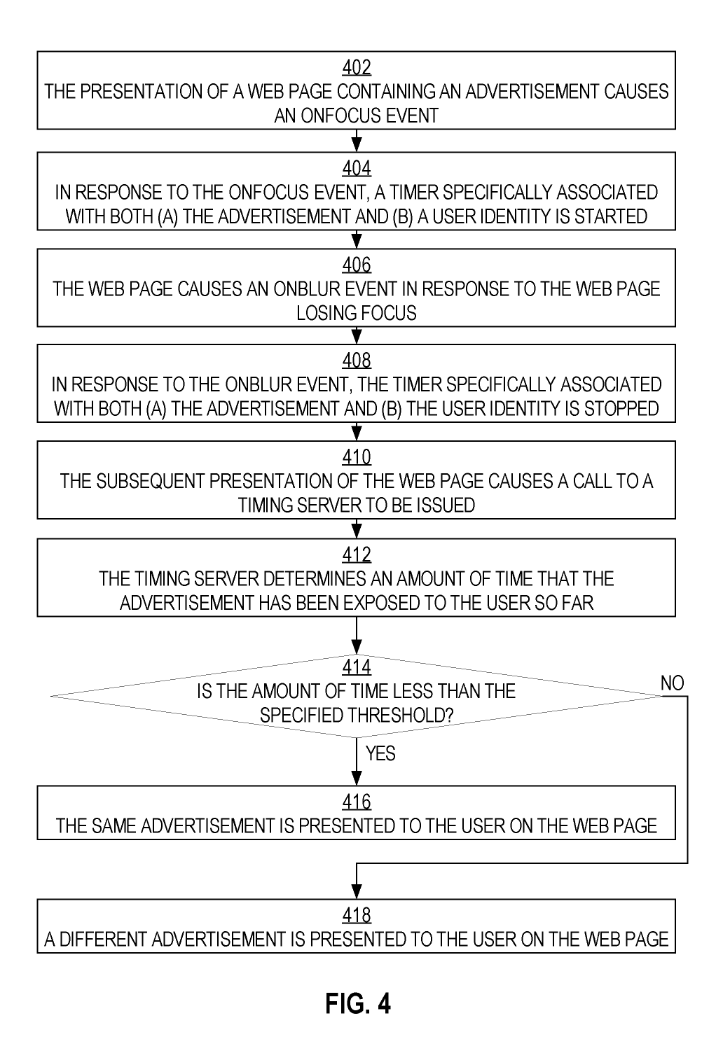

FIG. 4 is a flow diagram that illustrates a technique for ensuring that an advertisement is displayed to a user for a least a specified quantity of time, according to an embodiment of the invention. In block 402, the presentation of a web page containing an advertisement causes an onFocus event. In block 404, in response to the onFocus event, a timer specifically associated with both (a) the advertisement and (b) a user identity (i.e., the identity of the user to whom the web page was presented) is started. In block 406, the web page causes an onBlur event in response to the web page losing focus. This may be due to the web browser loading a different web page or in response to the web browser being closed entirely, for example. In block 408, in response to the onBlur event, the timer specifically associated with both (a) the advertisement and (b) the user identity is stopped. The timer's value is recorded in association with the advertisement and the user identity. This value represents the total amount of time that the advertisement has been exposed to the user so far.

In block 410, the subsequent presentation of the web page (e.g., in another session by the same user) causes a call to a timing server to be issued. In one embodiment, the call specifies the user identity. In block 412, the timing server determines an amount of time that the advertisement has been exposed to the user so far. In block 414, the server determines whether the amount of time is less than a specified threshold (e.g., 25 seconds). If the amount of time is less than the specified threshold, then control passes to block 416. Alternatively, if the amount of time is not less than the specified threshold, then control passes to block 418.

In block 416, the same advertisement is presented to the user on the web page. For example, this may be accomplished by dynamically constructing the web page prior to sending the web page to the web browser. Alternatively, in block 418, a different advertisement is presented to the user on the web page. In one embodiment of the invention, an advertising system that performs the foregoing technique refrains from charging or billing an advertiser at all for the display of a particular advertisement until the advertising system determines that the particular advertisement has been displayed to a user for at least the specified minimum amount of time.

### Limiting Exposure Time to Compensate for Declining Effectiveness Over Time

There is a clear increasing trend in the probability of reporting memory of an advertisement as a function of manipulated exposure time, with a log function providing a good fit. In experiments, the best fitting curve took on the form y=−0.009+0.106 log(x+1.681), where y is the memory response and x is the time of exposure. The basic shape of this curve, which shows the causal effect of exposure time on memory, can shed light on the results of the experiment. The basic logarithmic relationship predicts that relative differences in recall and recognition are difficult to attain beyond exposure times of 100 seconds. For this reason, and for the reason that most web pages are viewed for less than this long, a prudent accounting system may discount or disregard exposure times beyond this threshold.

In one embodiment of the invention, after an advertisement has been displayed on a web page for a specified maximum amount of time (e.g., 100 seconds), then that advertisement ceases to be displayed on that web page. As soon as the advertisement has been displayed for the specified maximum amount of time, code within the web page causes a different advertisement, not previously displayed on that web page, to be displayed instead of or in place of the original advertisement. In one embodiment, this replacement can be made via the execution of JavaScript on the page, and potentially using AJAX or similar technologies.

In one embodiment of the invention, as soon as an onFocus event is detected relative to the web page, JavaScript contained within the web page causes the web browser to execute code (potentially also specified within the web page itself) that starts a timer, and that replaces an original advertisement with a new advertisement as soon as that timer reaches a specified maximum value. The new advertisement may be retrieved from an advertisement cache resident on the same computer on which the web browser executes, or, alternatively, the web browser may dynamically request a new advertisement over the Internet from an advertisement server in response to the timer reaching the specified maximum value.

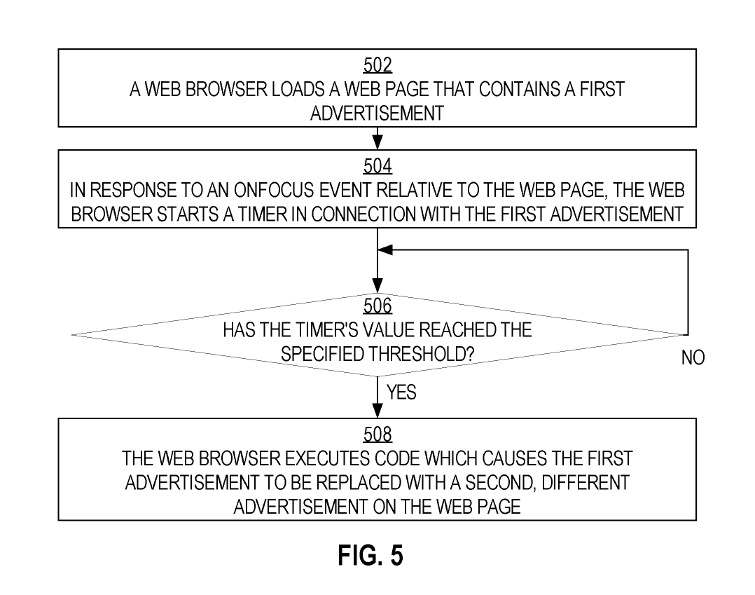

FIG. 5 is a flow diagram that illustrates a technique for replacing a first advertisement with a second advertisement after the first advertisement has been displayed for a specified maximum amount of time, according to an embodiment of the invention. In block 502, a web browser loads a web page that contains a first advertisement. In block 504, in response to an onFocus event relative to the web page, the web browser starts a timer in connection with the first advertisement. In block 506, the web browser determines whether the timer's value has reached a specified maximum amount of time yet. If the timer's value has reached the specified maximum amount of time, then control passes to block 508. Otherwise, control passes back to block 506.

In block 508, the web browser executes code, potentially specified within the web page itself, which causes the first advertisement to be replaced with a second, different advertisement on the web page. In one embodiment of the invention, the foregoing technique is then repeated relative to the second advertisement as well.

### Effects of Temporal Advertisement Ordering

The effect of showing an ad first versus second is discussed below. Users were exposed to an ad for 10 seconds then another for 60 seconds, or vice versa, or they were shown an ad for 5 seconds then another for 25 seconds, or vice versa. One might expect that due to their sudden appearance on the page, ads which appear second might have an attentional advantage over ads that load with the rest of the page's content. However, the opposite appears to be the case. The recall and recognition rate for the second ad does not have the steep increase at low exposure times as first ads do. Moreover, the combined recognition and recall rate for the second ad shown with 60 seconds of exposure was still 30%.

The early seconds after the page loads cause a higher increase in recall and recognition then the later seconds. So, considering a 10 second ad shown second, it appeared after 60 seconds. Also considering a 5 second ad shown second, it appeared after 25 seconds. This will cause the 5 second ad to be seen during a higher recall period of time than the 10 second ad. Thus the recall of the 5 second ad will be slightly inflated relative to the 10 second ad. One can make a symmetric argument which shows that the recall and recognition of the 25 second ad will also be slightly inflated relative to a 60 second ad shown second. Despite this fact, the first ad has a higher recall and recognition rate then the second. 5-10 seconds of exposure of the first ad shown is roughly equivalent to 60 seconds of exposure of the second ad shown. From an advertisers perspective having an ad shown second is less valuable the being shown first. Nonetheless, in either case, increasing the exposure time adds value.

### Hardware Overview

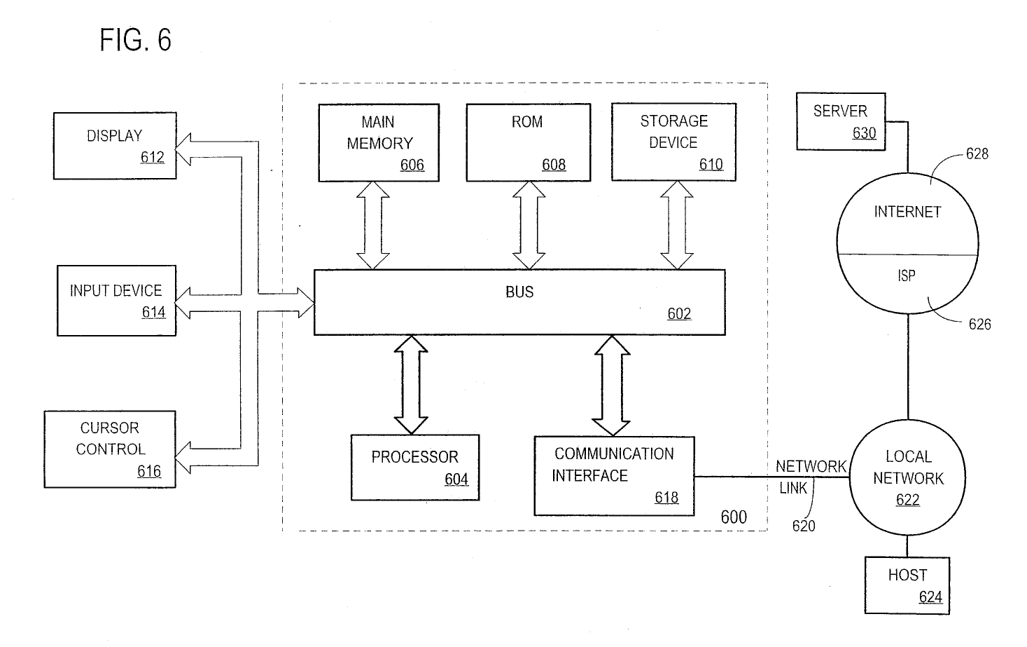

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” (or “computer-readable medium”) as used herein refers to any medium that participates in providing data that causes a machine (or computer) to operate in a specific fashion. In an embodiment implemented using computer system 600, various machine-readable media are involved, for example, in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications. Volatile and non-volatile media are non-transitory media.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

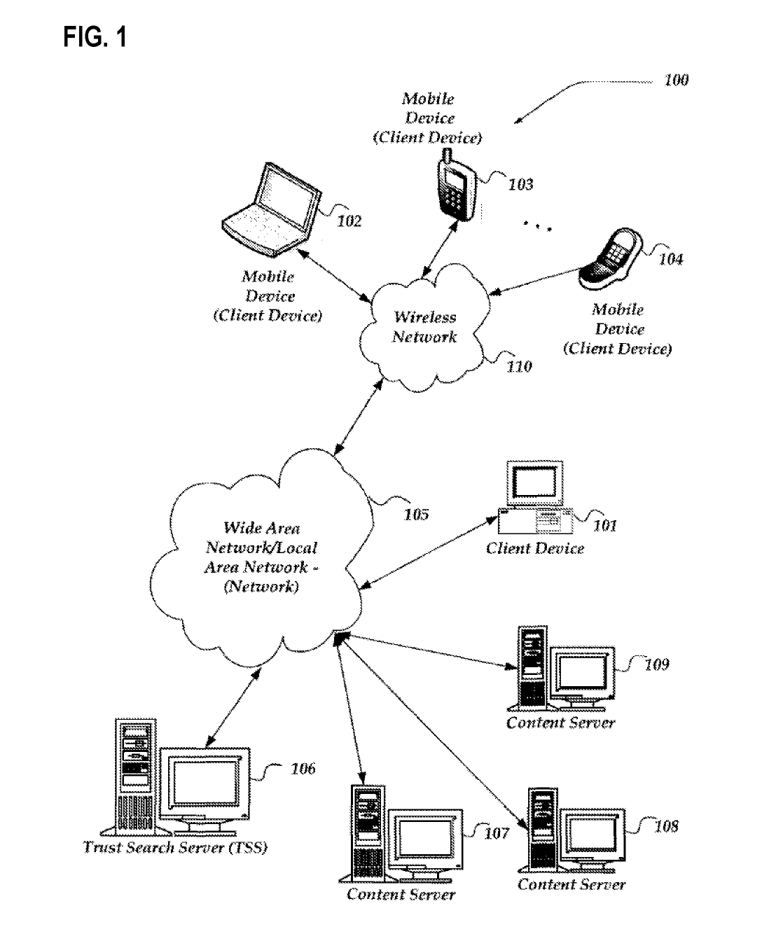

FIG. 1 is a schematic diagram illustrating an example embodiment of a network. Other embodiments that may vary, for example, in terms of arrangement or in terms of type of components, are also intended to be included within claimed subject matter. As shown, FIG. 1, for example, includes a variety of networks, such as local area local area network (LAN)/wide area network (WAN) 105 and wireless network 110, a variety of devices, such as client device 101 and mobile device 102, and a variety of servers, such as content server 107 and search server 106.

A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, GPS or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sport leagues). The foregoing is provided to illustrate that claimed subject matter is intended to include a wide range of possible features or capabilities.

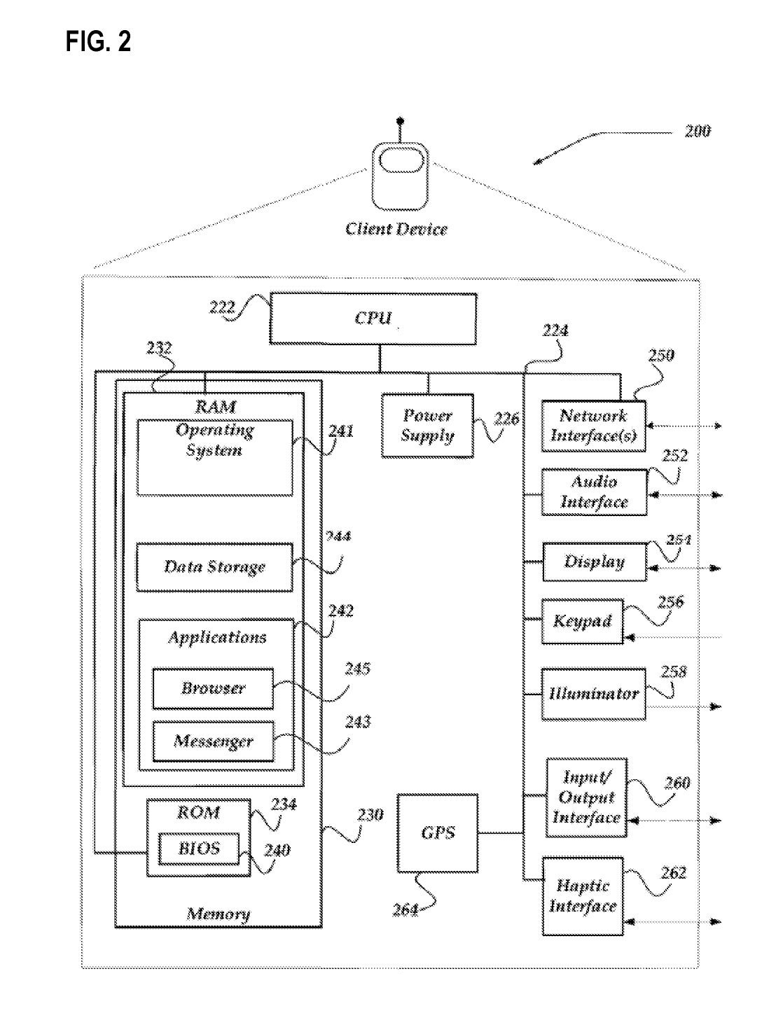

For example, FIG. 2 is a block diagram that illustrates a client device 200 upon which an embodiment of the invention may be implemented. Client device 200 includes a hardware processor 222 in communication with a mass memory 230 and coupled with bus 224 for processing information. Hardware processor 222 may be, for example, a general purpose microprocessor. Client device 200 also includes a power supply 226, one or more network interfaces 250, an audio interface 252, input/output interface 260, a display 254, a keypad 256, an illuminator 258, an input/output interface 260, a haptic interface 262, and a global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee or any of a variety of other wireless communication protocols. Network interface 250 is sometimes known as a transceiver, transceiving device, or network interface card (MC).

Audio interface 252 is arranged to produce and receive audio signals such as the sound of a human voice. For example, audio interface 252 may be coupled to a speaker and microphone (not shown) to enable telecommunication with others and/or generate an audio acknowledgment for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may remain active for specific periods of time or in response to events. For example, when illuminator 258 is active, it may backlight the buttons on keypad 256 and stay on while the client device is powered. In addition, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may, through other components, provide other information that can be employed to determine a physical location of the device, including for example, a MAC address, IP address, or the like.

Mass memory 220 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device, including being sent as part of a header during a communication, sent upon request, or the like. Moreover, data storage 244 may also be employed to store content and/or social networking information including text messages, address books, group member lists, or the like. For example, data storage 244 may include data, including cookies, and/or other client device data sent by a network device. Data storage 244 may also include image files, social networking data, location information data, or the like, for display and/or use through various applications.

Applications 242 may include computer executable instructions which, when executed by client device 200, provide such functions as calendars, contact managers, task managers, transcoders, database programs, word processing programs, screen savers, security applications, spreadsheet programs, games, search programs, and so forth.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 6th generation (2G, 3G, or 6G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

### Online Advertising and Monetization

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer system comprising:
one or more processors:
one or more storage media storing instructions which, when executed by the one or more processors, cause:
starting a timer in response to an occurrence of a first event relative to a first web page that contains a content item;
wherein the first event occurs in response to a web browser's presentation of the first web page on a screen of a computing device;
in response to an occurrence of a second event relative to the first web page, determining a total amount of time that passed between (a) the occurrence of the first event and (b) the occurrence of the second event;
determining whether the total amount of time is at least a specified minimum quantity of time; and
in response to determining that the total amount of time is less than the specified minimum quantity of time, causing the content item to presented, on the screen of the computing device, within a second web page that is different than the first web page.
